(19) United States
(12) Patent Application Publication
(10) Pub. No.: US 2016/0150363 A1
(43) Pub. Date: May 26, 2016

(54) Software Development Kit for Phone App with Location Data

(71) Applicants: Linda Hughes, Tucker, GA (US); Steven Shepherd, Bradenton, FL (US); Scott Capistrano, Valencia, CA (US); Christian Rossi, Santa Monica, CA (US); Benjamin Loveless, III, Valencia, CA (US); Joshua Guibault, Valencia, CA (US)

(72) Inventors: Linda Hughes, Tucker, GA (US); Steven Shepherd, Bradenton, FL (US); Scott Capistrano, Valencia, CA (US); Christian Rossi, Santa Monica, CA (US); Benjamin Loveless, III, Valencia, CA (US); Joshua Guibault, Valencia, CA (US)

(73) Assignee: AnyTransactions, Inc., Decatur, GA (US)

(21) Appl. No.: 15/010,433

(22) Filed: Jan. 29, 2016

Related U.S. Application Data
(63) Continuation-in-part of application No. 14/549,913, filed on Nov. 21, 2014.
(60) Provisional application No. 62/066,728, filed on Oct. 21, 2014.

(51) Int. Cl. H04W 4/02; H04W 4/00; H04W 64/00; G06F 9/44

(52) U.S. Cl. CPC H04W 4/02; G06F 8/70; H04W 4/003; H04W 64/00

(57) ABSTRACT

A smart phone used by an end user includes a positioning circuit; a computer readable memory; and an app resident on the computer readable memory. The app is configured to cause the positioning circuit periodically to determine a preferred location of the smart phone and transmit the preferred location to a remote server via a network. The app executes a plurality of local rules based on the preferred location and receives location-specific content that is selected based on the preferred location from the server via the network. The location-specific content is presented to the end user. A software development kit for generating a smart phone app facilitates quick app generation.

### CROSS-REFERENCE TO RELATED APPLICATION(S)

This application is a continuation-in-part of, and claims the benefit of, U.S. patent application Ser. No. 14/549,913, filed Nov. 21, 2014, the entirety of which is hereby incorporated herein by reference. This application also claims the benefit of U.S. Provisional Patent Application Ser. No. 62/066,728, filed Oct. 21, 2014, the entirety of which is hereby incorporated herein by reference.

### BACKGROUND OF THE INVENTION

1. Field of the Invention

The present invention relates to location tracking systems and, more specifically, to a location tracking system for interacting with a tracked smart phone.

2. Description of the Related Art

Many entities, such as businesses, have mobile smart phone apps that they use to integrate with their customer's smart phones. Generally these apps are custom designed and are built in an ad hoc manner that can be quite time consuming and expensive.

Most smart phones have global positioning satellite (GPS) capability. Such GPS capability is typically used in mapping apps and in proximity search functions. However, business apps do not take advantage of GPS locating functionality for the purpose of improving customer experience and promoting customer loyalty.

Therefore, there is a need for a app system that allows developers to generate enterprise-specific apps quickly so that such apps use the locating functionality on smart phones to improve interaction with the smart phone owners.

### SUMMARY OF THE INVENTION

The disadvantages of the prior art are overcome by the present invention which, in one aspect, is a smart phone used by an end user that includes a positioning circuit; a computer readable memory; and an app resident on the computer readable memory. The app is configured to cause the positioning circuit periodically to determine a preferred location of the smart phone and transmit the preferred location to a remote server via a network. The app executes a plurality of local rules based on the preferred location and receives location-specific content that is selected based on the preferred location from the server via the network. The location-specific content is presented to the end user.

In another aspect, the invention is a method of interacting with a smart phone, in which a set of business rules that set forth a course of actions that are based on a location of the smart phone is generated. The set of business rules is coupled to a smart phone locating engine and an inclusion/exclusion zone engine so as to generate a phone app. The phone app is downloaded from a server to the smart phone. A consent process that receives input from an end user indicates that the end user consents to the smart phone being located by the customer is executed. The smart phone locating engine is employed periodically to determine a plurality of locations for the smart phone, in which each location includes at least a latitude, a longitude and a precision indicator. A preferred location is selected from the plurality of locations wherein the precision indicator of the preferred location indicates that the preferred location is the most precise of the plurality of locations. In determining the preferred location, the locating engine can use data from various sources (e.g., GPS, cell tower and local devices) to improve the reliability of the preferred location. The business rules are applied to the preferred location and executing the course of actions based on the preferred location. The inclusion/exclusion zone engine is employed to determine when the smart phone is in an action zone. When the smart phone is in an action zone, location-specific content is delivered to the phone.

These and other aspects of the invention will become apparent from the following description of the preferred embodiments taken in conjunction with the following drawings. As would be obvious to one skilled in the art, many variations and modifications of the invention may be effected without departing from the spirit and scope of the novel concepts of the disclosure.

### BRIEF DESCRIPTION OF THE FIGURES OF THE DRAWINGS

FIG. 1 is a schematic diagram of one embodiment of a personal monitoring system.

FIGS. 2A-2C is a series of maps demonstrating use of the personal monitoring system.

FIG. 3 is a flow chart showing activation of the personal monitoring system.

FIG. 4 is a flow chart showing operation of one embodiment of a personal monitoring system server.

FIG. 5 is a flow chart showing operation of one embodiment of an application running on a cellular telephone used in personal monitoring.

FIGS. 6A-6C are a series of screens accessible by an officer or a manager.

FIG. 7 is a schematic diagram of one embodiment of a system for interacting with a smart phone.

FIG. 8 is a schematic diagram showing interaction between a customer system, a central server and a smart phone.

FIG. 9 is a is a flow chart showing one embodiment of a method for interacting with a smart phone.

FIG. 10 is a diagram showing interaction zones along a street.

FIG. 11 is a diagram showing a complex geometry defined by a plurality of action zones.

FIG. 12 is a diagram of one example of a user interface configured to be employed with a smart phone location system software development kit.

FIG. 13 is an image of one example of content displayed on a smart phone.

### DETAILED DESCRIPTION OF THE INVENTION

A preferred embodiment of the invention is now described in detail. Referring to the drawings, like numbers indicate like parts throughout the views. Unless otherwise specifically indicated in the disclosure that follows, the drawings are not necessarily drawn to scale. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Also, as used herein, “global computer network” includes the Internet. Also, as used herein, the term “smart phone” means a cellular telephone with GPS tracking capability and a graphical user interface. The term “app” means application that is run on a smart phone. The term “action zone” is a geographic zone within which a smart phone may be located.

U.S. Pat. No. 7,522,060, issued to Tumperi et al., discloses methods of employing a server to track an individual and is hereby incorporated by reference.

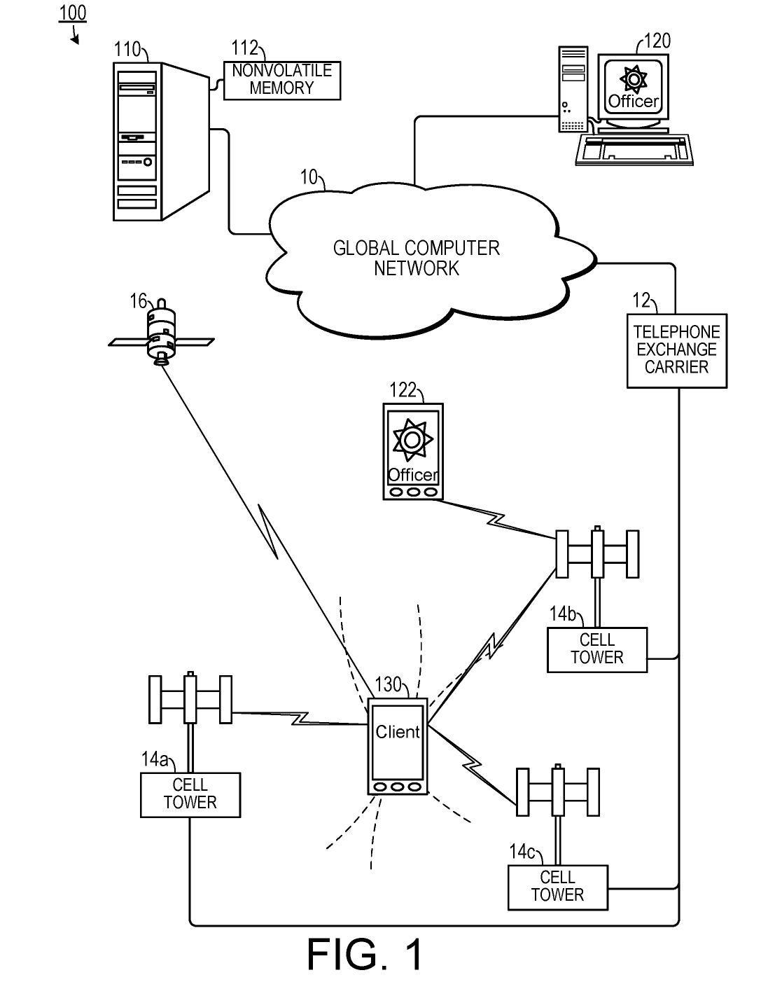

As shown in FIG. 1, one embodiment of a personal monitoring system 100, such as a system for monitoring an offender by a probation or parole officer, includes a central monitoring server 110 that includes a nonvolatile memory 112. The central monitoring server 110 is in data communication with a global computer network 10 and a telephone exchange carrier 12. The telephone exchange carrier 12 is in communication with one or more cell towers 14a-c. The central monitoring server 110 would typically be operated by a monitoring organization such as a governmental probation agency or a mobile worker management company (such as a home healthcare company), or it would be operated by a company with which an agency would contract for use of the system's services. A person being monitored, referred to herein as the “client,” (such as an offender on probation or parole, or a home healthcare worker) is in possession of a cellular telephone 130 that has circuitry necessary to acquire location data from a global positioning system (GPS) satellite 16 infrastructure. The monitored cellular telephone 130 typically can also acquire location data through cell tower triangulation.

An individual responsible for monitoring the client (such as a probation or parole officer or a healthcare system manager) would be able to communicate with the monitoring server 110 with a cellular telephone 122 or a computer 120.

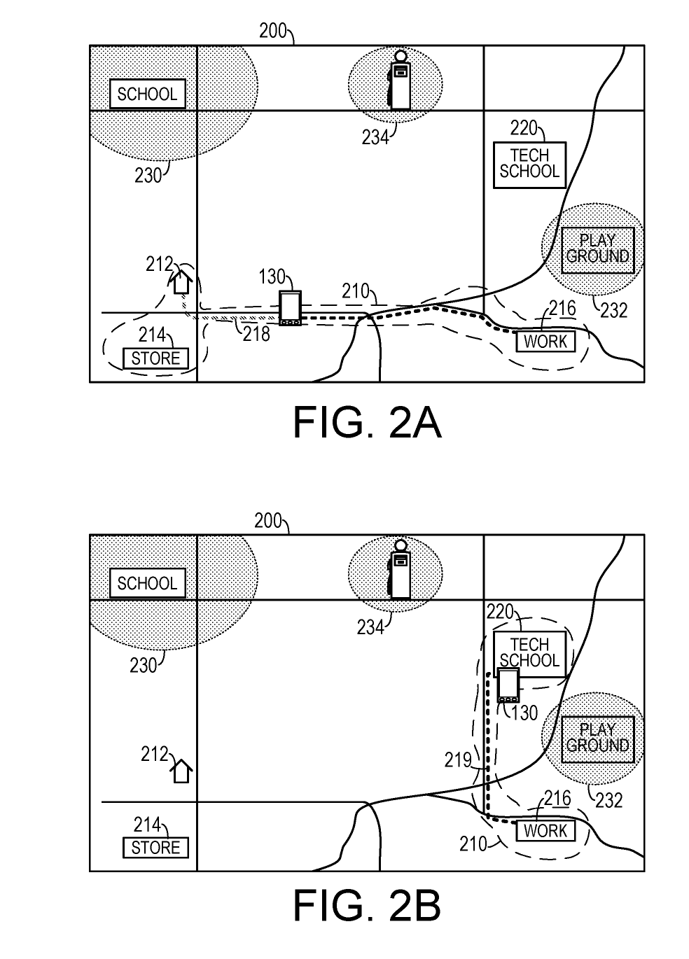

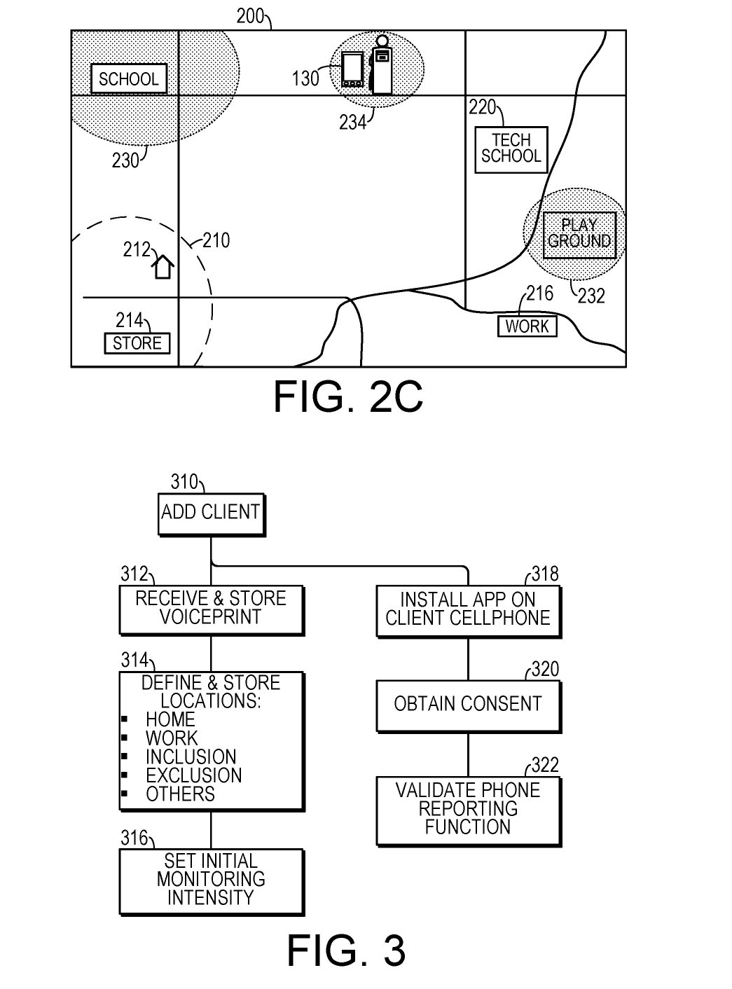

As shown in FIGS. 2A-2C, the system defines several inclusion zones, zones in which the individual is authorized to be at certain times, and exclusion zones, zones in which the individual is prohibited from being in at certain times. This example is typical for the scenario in which the system is employed to assist an officer in monitoring an offender. For example, as shown in FIG. 2A, at a certain time (e.g., during a “going to” or “coming from” work time period) an offender is authorized to be within a transit inclusion zone 210. This inclusion zone 218 could include the offender's home 212, a nearby store 214, the offender's place of work 216 and the most direct route 218 from the home 212 to the work location 216. If the system detects that the user's cellular telephone 130 is outside of the inclusion zone 210, then the system will generate an inclusion zone violation alert and transmit the alert to the officer.

Certain zones are also designated as exclusion zones. For example, if the offender is a sex offender, then the offender might be prohibited from being within a certain distance from child-oriented locations, such as schools 230 and playgrounds 232, at all times. Similarly, a drug addicted offender might be prohibited from going to a certain gasoline station 234 known as a location frequented by drug dealers. If the offender's cellular telephone 130 is detected at one of these exclusion zones, then the system will generate an exclusion zone violation alert and transmit the alert to the officer.

As shown in FIG. 2B, designation of the inclusion zone 210 (or possibly the exclusion zones) can be dynamic and based on time of day. In the FIG. 2B scenario, the system can allow the offender to go from work 216 to a school 220 at which the offender is taking classes during a specific time and along a designated route 219. At this time of day, the inclusion zone shown in FIG. 2A is no longer authorized. As shown in FIG. 2C, during an after-work and after-classes period, the inclusion zone 210 can be limited to an area around the offender's house 212 and the nearby store 214. Similar scenarios can also be effected in an application in which the client being monitored is a distributed service provider, such as a home health care worker.

As shown in FIG. 3, when a new client (e.g., an offender or a monitored worker) is added to the system 310, usually under the instruction of the monitoring individual, the system receives and stores a voiceprint 312 from the client's cellular telephone. Typically, this would involve the client calling a number associated with the system and reading a predefined phrase over the telephone and this would be done in the presence of the officer so as to ensure that the person providing the voiceprint is the actual client and not someone else. The system can even have the client provide several samples of the phrase to as to develop a range of acceptable responses. The monitoring individual can then define several locations 314, such as home, work, inclusion zones, exclusion zones and other locations of interest. The monitoring individual can also set an initial monitoring intensity 316 (e.g., query the client's telephone every five minutes to determine its location and request a voice sample every hour, etc.). The system will then download and install the system application on the client's telephone 318. They system will also obtain consent 320 from the client for the system to monitor and control the offender's telephone according to the protocols of the client's cellular telephone service provider. Once consent has been received, the system will validate the functionality of the application on the client's telephone 322.

Upon installation, the system can be configured to perform a quality check upon installation of the application on the cellular telephone. During a predetermined period the system can determine if a series of calls have been received and determine if the cellular telephone successfully maintains GPS service. At the end of the predetermined period (e.g., a 24 hour period), a phone quality indicator can be used to determine if the client's phone is of sufficient quality to be connected to the system. This action can be done by the central monitoring server, or by an application installed on the client's phone.

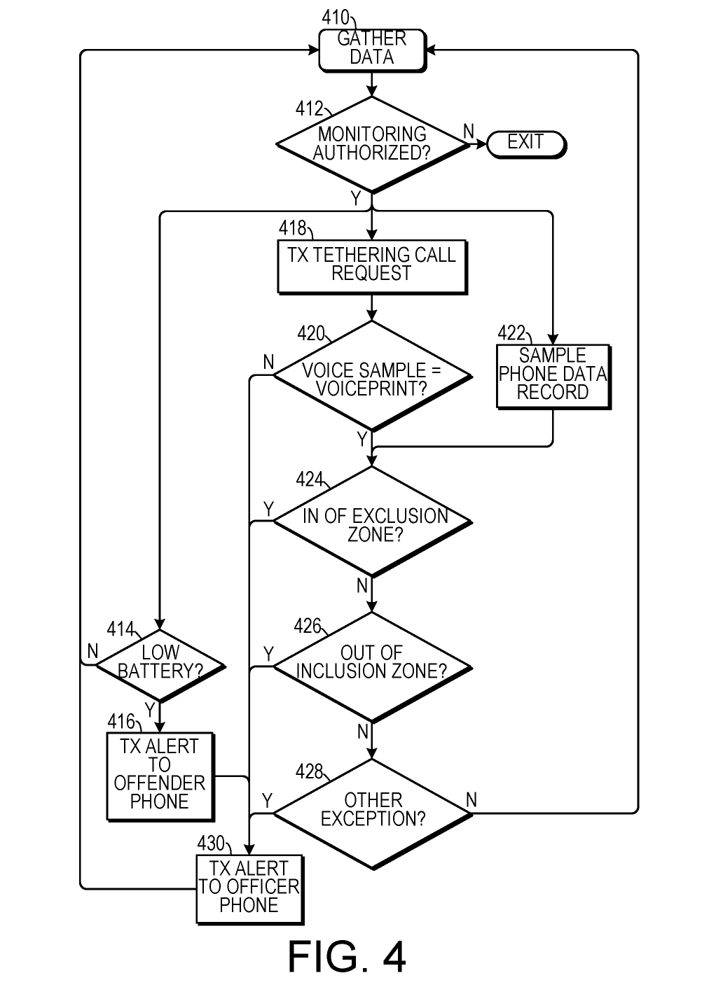

As shown in FIG. 4, in normal data gathering mode 410 relative to a specific client, the system, as the monitoring system, determines if monitoring of the client is currently authorized 412, if not it will not begin monitoring the client. For example, if an offender's sentence has been completed, then the system will no longer be authorized to monitor that client. If authorized, then periodically the system will execute at least three threads of operation substantially in parallel, including detecting if the client's telephone has a low battery 414 and, if so, it will transmit a low battery alert 416 to the client and a similar alert to the monitoring individual 430. The system will also periodically transmit a tethering call request 418 to the client's cellular telephone and receive a voice sample from the client. The monitoring server will compare the voice sample to the voiceprint and, if they do not match within acceptable tolerance, the system will alert the monitoring individual 430 of the mismatch.

If the client fails to respond to a tethering call, the system can attempt to call the client several more times at a predetermined interval (for example, two more times at five minutes apart). If the client still fails to respond, the system can alert the monitoring individual, who may use the system to go to the client's last known location. Also, if the client makes changes to the telephone that would interfere with the monitoring, the monitoring individual can be notified immediately.

The system also periodically queries the client's cellular telephone to receive such data as current location data 422 (which is typically done during the tethering call and can also be done at a more frequent sampling periodicity than the tethering call frequency). From the data received from the client's cellular telephone, the system will determine if the client is in an exclusion zone 424 and, if so, it will issue an exclusion zone violation alert 430, if not, the system will determine if the client is outside of the current inclusion zone 426 and, if so, it will issue an inclusion zone violation alert 430. If not, it will determine if the client's cellular telephone indicates that any other type of exception to the conditions of the user's monitoring has occurred 428 and if so, it will issue an alert 430, otherwise it will repeat this monitoring. As will be readily understood, this is a simplification of the operations executed by the monitoring server and many other functions and routines are typically executed in this process.

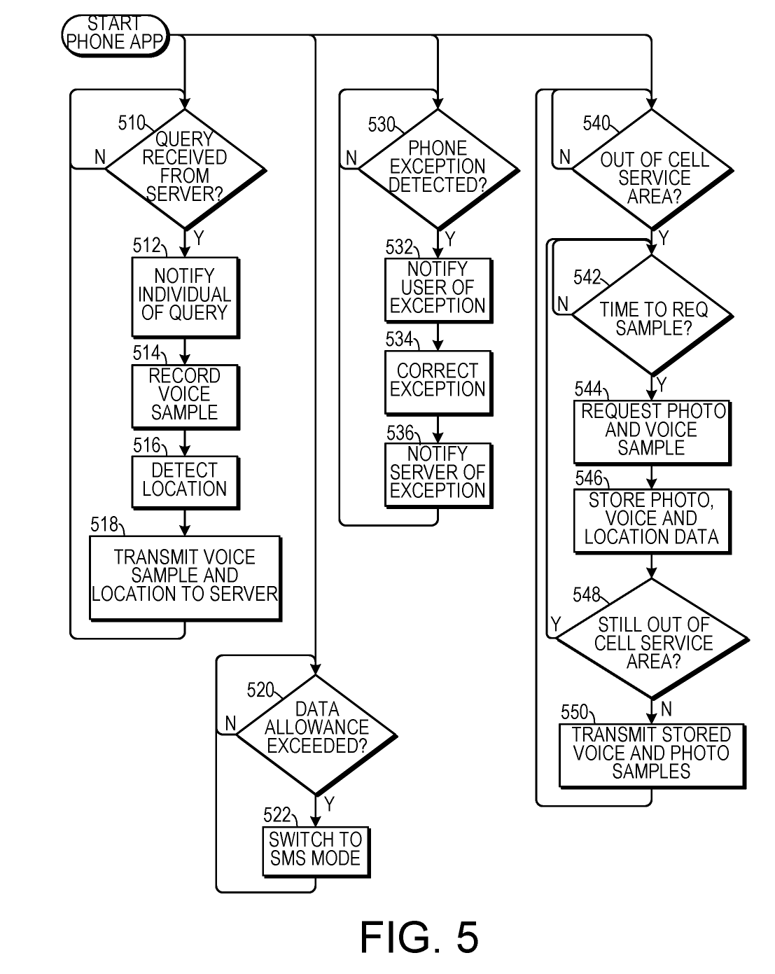

As shown in FIG. 5, the client's cellular telephone executes several different processes, including a process used to query the client in which the cellular telephone determines if a query has been received from the monitoring server 510. If so, the cellular telephone notifies the client of the tethering call query 512, which can be done either through sounding a ring tone or through causing the telephone to vibrate (or both). The cellular telephone will then record a voice sample 514 from the user (or, alternately, it can transmit the voice sample directly to the server), it also detects its location 516 using its GPS capability, or by cell tower triangulation (or both) and then transmits 518 the voice sample and location data to the central monitoring server.

In another process, the phone application can determine if the client's data allowance has been exceeded 520 according to the client's cellular service plan. If so, it can switch its mode so that it communicates with the central monitoring server using SMS technology 522.

In another process, the phone application can detect certain exceptions 530 (for example, when the client attempts to put the phone in “airplane” mode or turn off the phone's GPS capability, etc.). When such an exception occurs, the app will cause the phone to notify the user of the exception 532 (e.g., with a text message that states “Airplane mode not authorized”), correct the exception 534 (e.g., reset the phone from airplane mode back to normal operating mode) and then notify the central monitoring server 536 of the exception.

In another process, the phone application can detect when the client's phone does not have cellular service 540 and, if so, place it in a local verification mode. In this mode, it periodically queries the user, stores the data locally and then transmits the data to the central server once cellular service is reestablished. The phone application will determine if the period to the next local query has expired 542 and, if so, it will notify the client and request 544 that the client provide both a voice sample and take a “selfie” photograph using the client's phone. The resulting voice sample and photograph are stored digitally along with timestamp data and current phone location data (typically acquired using the phone's GPS circuitry) on the cellular phone 546. The application will then detect whether the phone has regained cellular service 548 and if so, it will transmit 550 all of the stored voice, photo, location and timestamp data to the central monitoring server, which stores the data for analysis and later access. For example, the server can compare the voice samples and photographs to the client's voiceprint and a stored photograph of the client and notify the monitoring individual of any mismatches. Other methods of identifying the client may also be employed, including: fingerprint identification, retinal identification, vein mapping identification, bone mapping identification and other biometric identification.

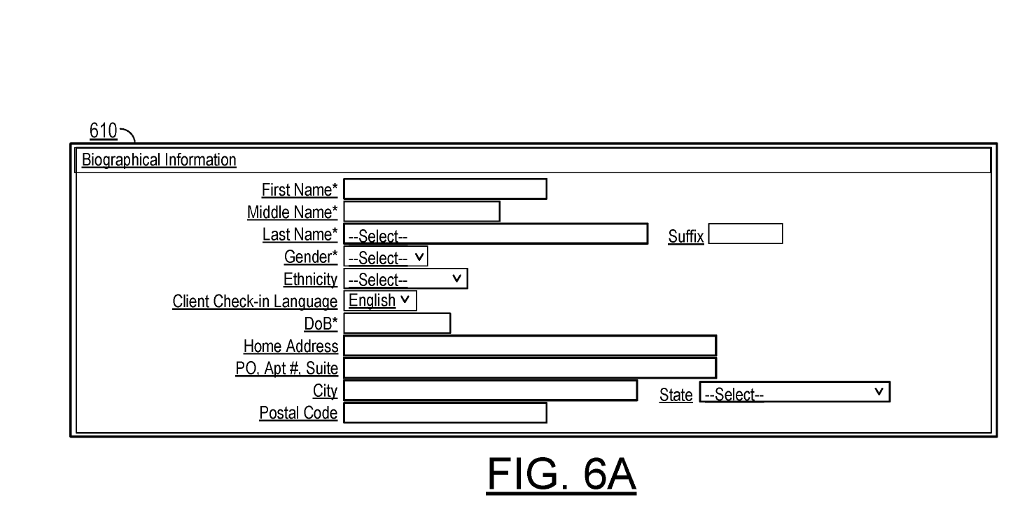

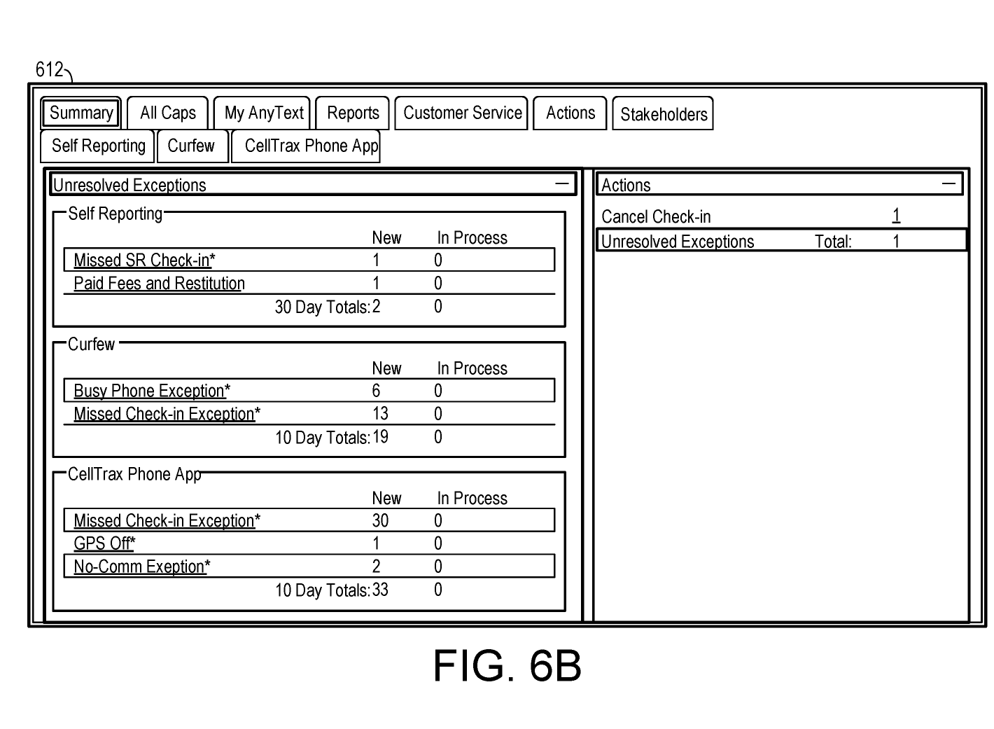

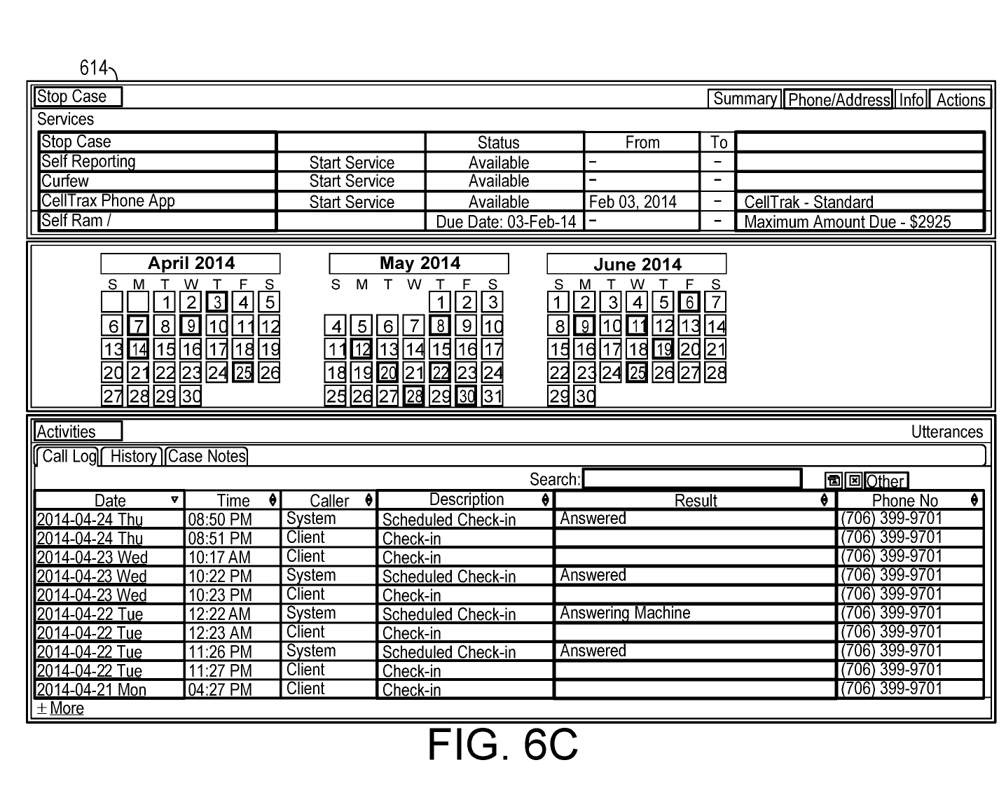

As shown in FIGS. 6A-6C the system presents several screens to the monitoring individual, which can be accessed either via a computer or the monitoring user's cellular telephone. Typically, all of the screens are accessible through a dashboard accessible by the monitoring individual. For example, FIG. 6A includes a new client input screen 610 by which the client's name, contact information and other relevant information (such as information describing the client) are input to the system. The information in this screen could be used by system to designate the client's home location.

A summary screen 612 is shown in FIG. 6B. This screen can summarize important events (e.g., exceptions, curfew compliance, etc.) associated with the client. It can also summarize parameters associated with the client's cell phone.

As shown in FIG. 6C, the dashboard can include a screen 614 that lists all actions for a particular client over time. For example, it can list the date and time of each tethering call in which the client was located. It can also list any exceptions (e.g., voice mismatch, failure to respond, etc.) detected. The monitoring individual can select a specific event and the system will display additional information, which could include a display of a map showing the client's location during the selected event. A satellite view of the location, along with the Cartesian coordinates of the location, may also be supplied to assist the monitoring individual in understanding the location of the client. This may be useful in helping an officer take action, if necessary.

A monitoring individual may also be presented with a page that lists all of the clients assigned to the individual. A symbolic summary may be presented next to each name. For example, a green box next to a client's name may indicate that the client is completely in compliance with the conditions imposed on the client, a yellow box might indicate minor exceptions associated with the client and a red box might indicate that the client has caused significant exceptions. Another symbol might act as an icon that links to a page of notes about the client. Clicking on another symbol might cause a count or a list of case actions associated with the client to appear on the screen (e.g., actions such as: placing of a tethering call, detection of the client at a new location, sending of a text, a change of alert parameters set by the monitoring individual, etc.). Also, next to the client's name can be a link showing the date and time of the last location of the client. Clicking on the link may cause the display of a map locating the client. The map can also show the path of tracked locations over a period of time, including a starting point of the client at the beginning of the period, the ending point at the end of the period and the route taken by the client during the period.

One screen can show a matrix of different time periods (e.g., one hour periods) for several different contiguous days. When a monitoring individual clicks on a specific period, the system can display a list of relevant information, including locations at which the client was detected during the period and the number and types of exceptions that occurred during the period. The periods in the matrix can be color coded to indicate, for example, that no issues were detected for the client during the period (e.g., with a green box) or that there is an unresolved exception that occurred during the period (e.g., with a red box). Similarly, other issues can be symbolically represented during a given period, such as: no issues; no locations reported for the client; existence of unresolved exceptions; airplane mode on; GPS turned off; client in inclusion zone; client in exclusion zone; client missed tethering call; client late in responding to tethering call; existence of multiple exceptions; no communication with client detected; periods during which client is to be in inclusion zone (which could be represented, for example, as a blue outline around the boxes in the inclusion zone periods); and the number of different locations detected during a given period. The dashboard will also give the monitoring individual the option of clearing exceptions for the client when the monitoring individual believes that the exceptions are acceptable. As a result, this status screen gives the monitoring individual a quick snapshot indicating the client's compliance.

One screen can show a calendar, on which expected locations for a client over time and other significant events of interest are displayed to the monitoring individual. The calendar can also be used to remind the monitoring individual of such events such as: a scheduled call, a court date at which the client is to appear, a scheduled drug test for the client, etc.

The system can also generate a location reliability assessment based on the global positioning system location data and the cellular system location data. The location reliability assessment provides an indication of reliability of the first client location, which can be useful to the monitoring individual in determining if the reported location is really a violation or just a technical anomaly (e.g., as a result of weather influences, etc.). The system can calculate the speed associated with the client's cellular telephone based on location data received from the first client cellular telephone and use the speed in determining the location reliability assessment. For example, if the client's speed is unrealistically high, it would indicate that the location data may not be reliable. Similarly, an indication of the number of different cellular towers are in communication with the client's cellular telephone can be used in the reliability assessment, as consistent data from many different cell towers would indicate a higher level of reliability than data from a single tower.

The system can receive an indication from the client's cellular telephone that the global positioning system module has been disabled. Once received, the system can transmit a command to the client's phone causing it to enable its GPS system (this could also be done locally by the application resident on the phone). The monitoring individual can also be notified by the system of the client's attempt to disable the GPS module. The system (or the local application of the phone) can handle an attempt by the client to place the phone in airplane mode in a similar manner.

The system can receive data about operational parameters of the client's cellular telephone (e.g., low battery life remaining, high data error rate, etc.). If the cellular telephone is operating below a predetermined operating threshold, the client and the monitoring individual can be notified of the phone's operating state through an alert. The state can also be recorded in a log that can be accessed by the monitoring individual at a later time. The system can also alert the monitoring individual if the client attempts to disable the identification ability of the client's cellular telephone.

The system can also receive data describing a browser history for client's cellular telephone and determine if the client has attempted to access restricted web sites (e.g., pornographic cites, drug related sites, and crime-related sites, etc.). When the client has attempted to access a restricted site, the monitoring individual is alerted to the attempted access. The browser history may also be stored in a log by the system.

The system also detects when the client's telephone has employed call forwarding in responding to a tethering call (which would indicate that the client is not at the same location as the client's phone). If call forwarding is detected, the monitoring individual may be alerted. The same can be done when the client attempts to respond to a tethering call with the client's phone set up to participate in a three-way call, which might also indicate that the client is at a different location than the client's phone.

In one embodiment, the system is configured to detect when the client's phone has been at a single location for more than a predetermined period of time. Once detected, the system can initiate a tethering call to verify that the client is with the client's phone. At certain times, the system can refrain from sending tethering call requests, thereby allowing the client to sleep or to refrain from disturbing the client while at work or while in class.

The system can also receive from the monitoring individual changes to the sampling frequency based on certain events. For example, if the monitoring individual suspects the client of participating in a crime, the sampling frequency can be increased so that the monitoring individual can better track the client and record the client's locations with high precision, which can be used in evidence at a later time. On the other hand, the monitoring can reduce sampling frequency (thereby saving battery life) if the client has been fully compliant for a long period of time. The system can also automatically adjust sampling frequency based on past behavior of the client. For example, if the client is detected as being mobile, the sampling frequency can be increased so as to provide a more precise record of the route taken by the client. If the monitoring individual issues a current location request for the client, the system can query the client's phone and provide an immediate current location.

In one embodiment, the system can determine when the client's phone is within a predetermined distance from another client's phone and then alert the monitoring individual of the proximity. This can be useful, for example, when the first client is a drug addict and when the second client is a known drug dealer. The system can also detect when the client is within a predetermined distance from a location or event, such as a known hang-out for drug users or a location of a robbery.

When monitoring of the client cellular telephone is no longer authorized, for example as a result of the completion of the parole period, the system will then disable the monitoring of the client's cellular telephone. This can be done automatically, thereby preventing unauthorized monitoring.

In one embodiment, the local application on the client's phone detects when a data allowance for the cellular telephone set forth in a cellular service plan subscribed to by the client has been exceeded and causes the phone to communicate with the central monitoring server via SMS technology when the data allowance has been exceeded. In one embodiment, the local application monitors operating parameters and management of the telephone, including loading updates to the local application as they become available. The application that monitors the performance of the primary app, reports on the performance to the server, and downloads new versions or replaces the current version of the app on the phone.

In one embodiment, the system records all exceptions associated with a client over a predetermined period and then generates a behavior rating for the client. The client may be assigned a positive rating when the plurality of exceptions are less than a predetermined threshold and assigned a negative rating when the plurality of exceptions exceed a predetermined threshold. This can be used by the monitoring individual in deciding how lenient to be with the client. The system can also be operated in a low intensity mode if the monitoring individual so desires. This can be done in the case of clients with a good behavior rating so as to conserve battery life. For example, in this mode a client can be sent a tethering call only once a week as opposed to every half hour.

In one embodiment, the system records a plurality of telephone operational parameters indicative of a functionality state of the cellular telephone during a predetermined period after installation of the application on the cellular telephone. Based on the recorded information, the system generates a phone rating in which the cellular telephone is assigned a positive rating when the functionality state is greater than a predetermined threshold and in which the cellular telephone is assigned a negative rating when the functionality state is less than the predetermined threshold. This can be used by the monitoring individual to instruct the client to buy a new telephone.

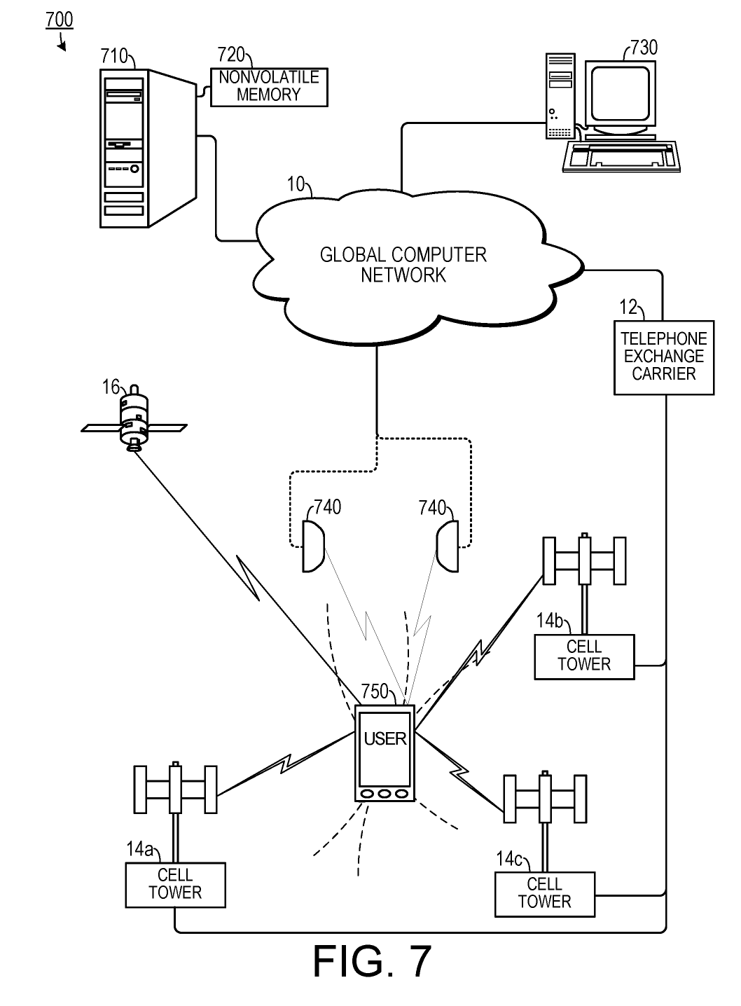

One embodiment, as shown in FIG. 7, is a system that employs the locating functionality in the embodiment disclosed above to allow information sharing between a customer and a plurality of related end users. This system 700 includes a remote server 710 that employs a nonvolatile computer readable memory 720 in communication with the global computer network 10. A telephone exchange carrier 12 (in communication with a plurality of cellular towers 14a-c) and a customer-operated computer 730 are also in communication with the global computer network 10.

A smart phone 750, which is typically operated by an end user, is configured to be in communication with the cellular towers 14a-c and short distance wireless communication devices 740 (such as iBeacon® local wireless devices available from Apple, Inc.). The smart phone 750 also has GPS capability. Therefore it can locate itself through receiving a signal from a GPS satellite 16. It can also be located through cellular tower 14a-c triangulation or local proximity devices 740 triangulation.

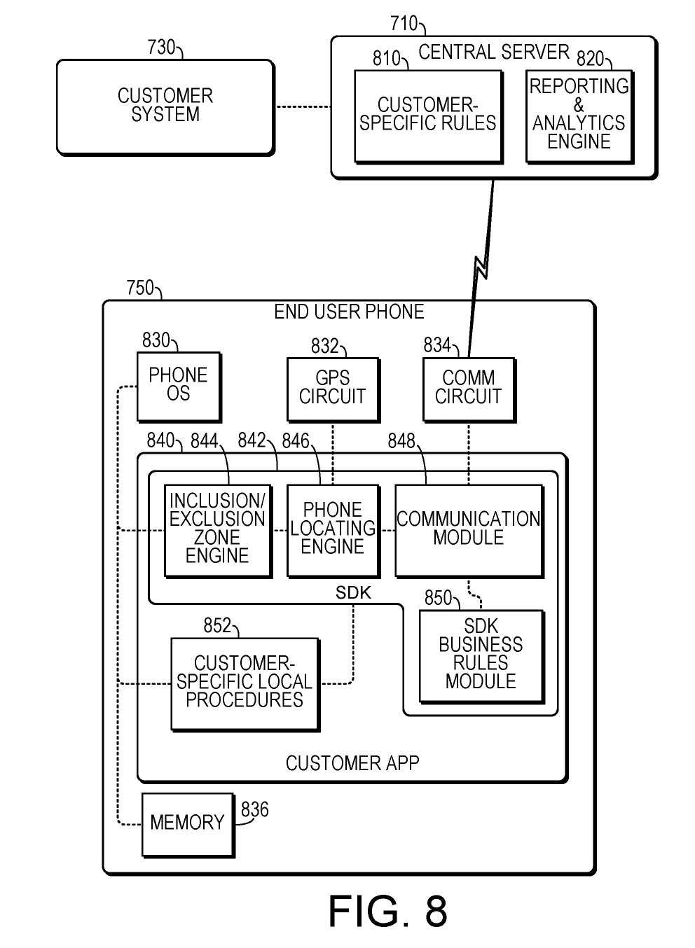

As shown in FIG. 8, the end user's smart phone 750 includes a communication circuit 834 that communicates with the remote server 710, which is also in communication with the customer-operated computer 730. The remote server 710 maintains a set of customer-specific rules 810 that are executed in response to the end user's smart phone 750 meeting certain criteria (such as being within a predefined action zone). The remote server 710 also maintains a reporting and analytics engine 820 that analyzes behaviors associated with the end user's smart phone 750 and that generates reports relating those behaviors, which are delivered to the customer-operated computer 730.

The end user's smart phone 750 will also include an operating system 830, which controls operation of the smart phone 750 and interfaces with the engines and modules resident on the smart phone 750, a memory 836 and a GPS chip set circuit 832. A phone app 840 is downloaded onto the phone from the remote server 710. The phone app 840 includes a plurality of customer-specific local procedures and rules 852 that are executed locally under certain conditions and a software development kit (SDK) package 842. The SDK package 842 includes a plurality of engines/modules, including: an inclusion/exclusion zone engine 844 used to determine whether the smart phone 750 is inside either within an inclusion zone or within an exclusion zone; a phone locating engine 846 that causes the smart phone 750 to detect its location; a communication module 848 that is used for communicating data relative to the app 840 with the central server 710; and an SDK business rules module 850 that manages business rules relative to the app 840.

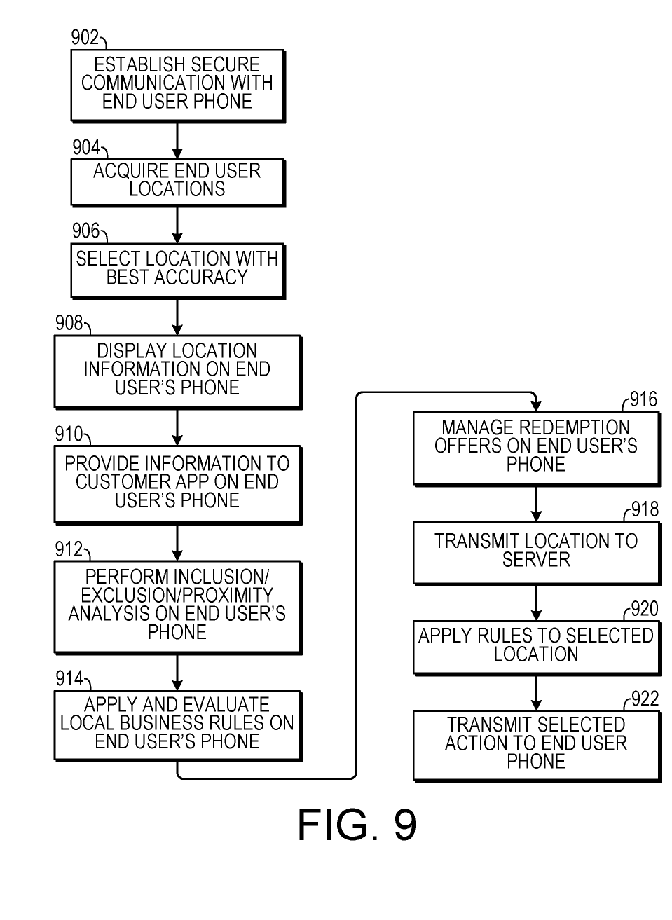

In operation, as shown in FIG. 9, the remote server 710 performs a plurality of operations, starting with establishing a secure communication 902 with the user smart phone 750. When starting a communication with a given smart phone, the server will use an authentication protocol (such as a nonce-based authentication process including both a server nonce and a client nonce) that ensures that each server/end user smart phone communication is between the server and a single smart phone. A nonce is an arbitrary number used only once in a cryptographic communication and is typically a pseudo-random number that is used only once in establishing a secure communication. Such an authentication protocol uses nonces to ensure that old communications cannot be reused.

Once a secure communication is established, the smart phone 750 will detect its location repeatedly over a period of time, resulting in a plurality of locations being stored in the memory. This locating routine will occur periodically, so as to determine the phone's location at any given time. Under certain circumstances, the frequency of phone location can be changed. For example, when the phone is detected to be in a travelling action zone (e.g., in an area where it is determined to be moving on an interstate highway), or when the smart phone is detected as being moving at a high speed, the frequency of locating the phone could be decreased to save resources and conserve phone battery power. Similarly, if the phone is detected to be within a confined space, such as a department store, the locating frequency can be increased so as to give real time precise location of the cell phone. Also, the developer can define certain action zones such that the smart phone samples at one rate (such as a relatively high rate) while the smart phone is within an action zone and samples at a second rate (such as a relatively low rate) when the smart phone is located outside of an action zone.

Each location will include a latitude, a longitude and a radius. The radius is an indicator of the precision of the location, in which a smaller radius indicates a more precise location. The phone locating engine 846 will select the most precise location 906 and will display it 908 on the end user's phone and provide that information to the app 840. The app 840 will perform an analysis 912 based on the selected location and data describing geographic zones received from the server 710 to determine if the phone is within a predetermined zone. Based in this analysis, the app will apply any local business rules 914 received previously received from the server to the end user's phone and will manage redemption offers 916 resulting from the application of such rules. The app will also transmit 918 the selected location to the server, which will apply rules 920 stored at the server to the phone based on its location. Certain actions will also be transmitted 922 to the end user phone.

If the app determines that the smart phone has traveled more than a predetermined distance from a location, it can request from the server a new set of business rules that correspond to the new location. The app can estimate speed of the smart phone and estimate a new location based on the speed, elapsed time and previous location. This can allow independent running of the app when the smart phone is not locatable through GPS or when it is outside of cellular service range.

For example, a customer coffee shop chain can use the system to develop an app to be installed on the smart phones of its regular patrons who agree to subscribe to the app. Such an app can determine if the phone is within a predetermined range of one of the coffee shops in the chain and, if so, it can apply certain rules to the phone. In one example, if the phone is within a range of a selected one of the coffee shops and if the time is during a period that the coffee shop chain (or the local coffee shop) wants to increase business, a coupon for something of value at the coffee shop can be transmitted to the phone so that the patron can bring the phone to the coffee shop and redeem the coupon.

Business rules can be downloaded from the server to the smart phone dynamically, depending on various factors. For example, when the phone is near a first location, a first set of business rules relevant to the first location can be downloaded to the phone. When the phone moves away from the first location and closer to a second location, then a second set of business rules relevant to the second location can be downloaded to the phone. For example, if a customer is a chain of coffee shops with several stores around town, if the phone within range of a first store, then business rules specific to the first store can be downloaded to the phone. If the phone moves away from the first store and closer to a second store in the chain, then a set of business rules specific to the second store can be downloaded to the phone.

The app also transmits new locations of the phone to the server, which can keep a record of movement patterns. This information along with timestamp data, and customer purchasing data (which can be received from customer locations) can be analyzed by the server and analytic reports regarding individual end users or groups of users can then be provided to the customer.

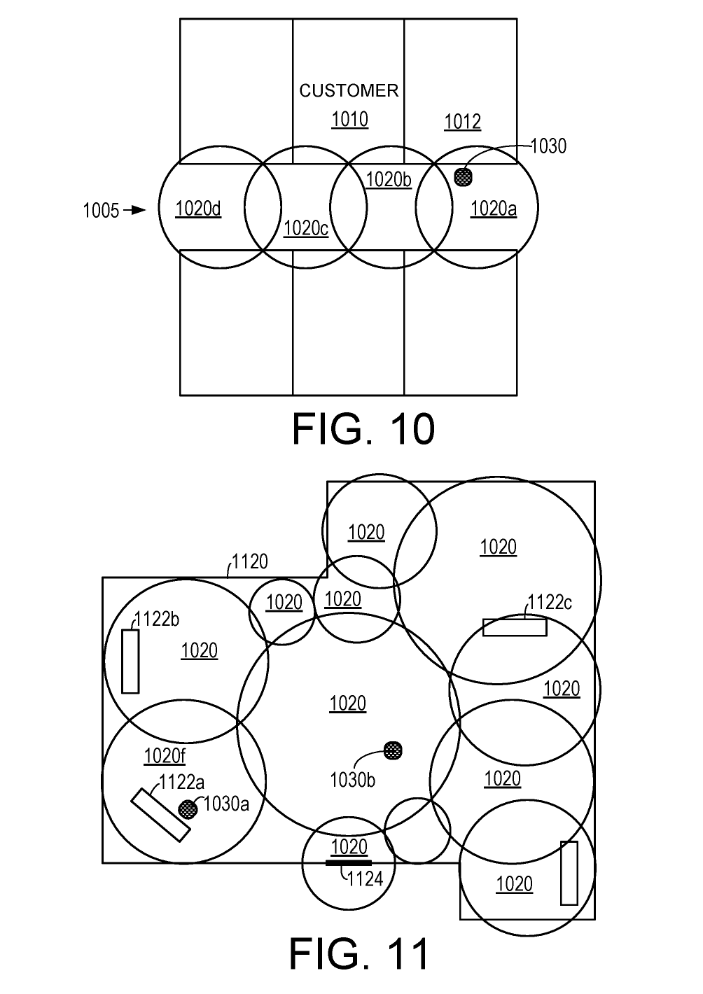

As shown in FIG. 10, a customer 1010 could be at a location along a street 1005 and the customer app can define a plurality of inclusion zones (action zones) 1020a-d that would be of interest to the customer 1010 and which are stored on the server or on the smart phone. In the example shown, the customer has designated circles that include the street 1005 and the entrances to other stores on the street 1005 as inclusion zones. When a potential patron is within one of these zones 1020a-d the app will apply rules relative thereto to the patron's phone 1030. For example, when the patron 1030 exits store 1012, the app would detect that the phone 1030 has entered inclusion zone 1020a. The app can then transmit to the phone 1030 a notification that the user is close to the customer's store 1010 and a coupon offering the patron something of value for coming to the customer's store 1010.

As shown in FIG. 11, the customer can define a complex pattern of inclusion/exclusion zones 1020. The example shown could be inside a department store 1120 with counters 1122a-c in different departments. In this case, zone 1020f could be around a cosmetics counter 1122a. When the phone of a patron 1030a who has a purchase history of purchasing both cosmetics and fashion accessories is detected within zone 1020f, the app can suggest a fashion accessory that might be of interest to be displayed on the phone of patron 1030a and download a coupon for that accessory or a video advertisement about it. The app can also provide directions within the store 1120 to the fashion accessories counter 1122c where the coupon can be redeemed. A department store 1120 might include local short distance wireless communication proximity sensor devices to determine a more precise location for the phone and also to transmit information to the phone.

The system can also detect when the phones of certain patrons (such as “high spending” patrons) have passed through the entrance 1124 of the store and can locate such patrons within the store. Personnel at the store can then be alerted to the location of the patron so as to provide better service. If, for example, it is known that such a patron tends to purchase sporting goods, the store personnel can be alerted to that fact so as to direct the patron to the sporting goods counter 1122b.

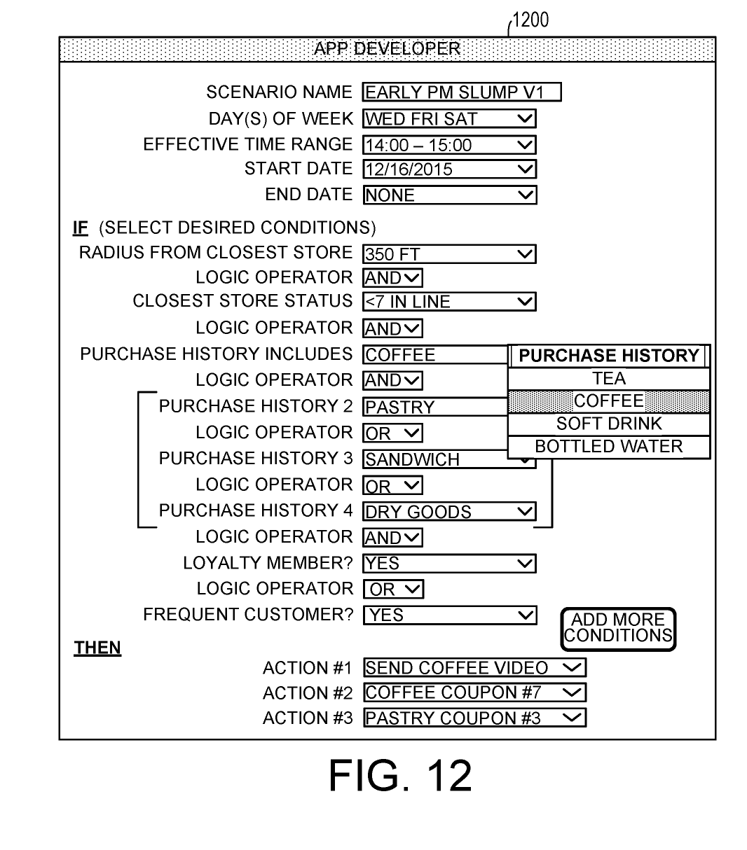

As shown in FIG. 12, the software development kit can include a developer user interface 1200 that includes a plurality of data entry fields that allow the customer to develop a set of business rules quickly for various scenarios. With this type of interface, the customer's app developer can generate a scenario that sets forth value ranges for such variables as: day of the week; time range; distance from store; indicia of how busy a store is during the time period and even known preferences of potential patrons. The developer can also specify that when a patron is sensed to meet all of the criteria of the variables and when the patron's phone is within a predetermined range, then certain actions will be taken by the app on the patron's phone, such as downloading advertising videos, downloading suggestions and downloading coupons. Once the developer has completed a scenario, or a plurality of scenarios, a rule set corresponding to such scenarios will be created and downloaded to the server and to the end user's smart phone. The system couples the set of business rules to the software development kit engines (including a smart phone locating engine and an inclusion/exclusion zone engine) so as to generate a phone app. The phone app is downloaded from the server to the smart phone.

The server can store the locations of the smart phone over time to track movement patterns of the smart phone. The server can also associate actions taken by the smart phone and its user with corresponding locations of the smart phone. Additionally, the server can integrate with other systems to associate the locations of the smart phone with actions of the end user. For example, the server can track purchasing behaviors of the user corresponding to various locations of the user's smart phone. This information can be used in analytical reports generated by the server.

It can also be used to modify the business rules dynamically. For example, if the system notices that a patron of a coffee shop typically buys one type of coffee at that shop, the business rules relative to that patron at that location can be modified so that the coupon downloaded to that patron's smart phone is for something that purchasers of that type of coffee are more likely to buy.

When the smart phone approaches an area of limited cellular service connectability, the system can download the set of business rules to the smart phone so that the smart phone can execute the business rules when it does not have cellular service.

This system can also be configured to facilitate group activities. For example, when the server determines that a predetermined number of smart phones are within a predetermined distance of the preferred location and that the corresponding end users have a common interest, the server can query each of the smart phones to determine if each smart phone user desires to participate in a group activity. The server can transmit content specific to the group activity to each user that has indicated a desire to participate. For example, the system could be used to promote impromptu social events and complex on-line gaming.

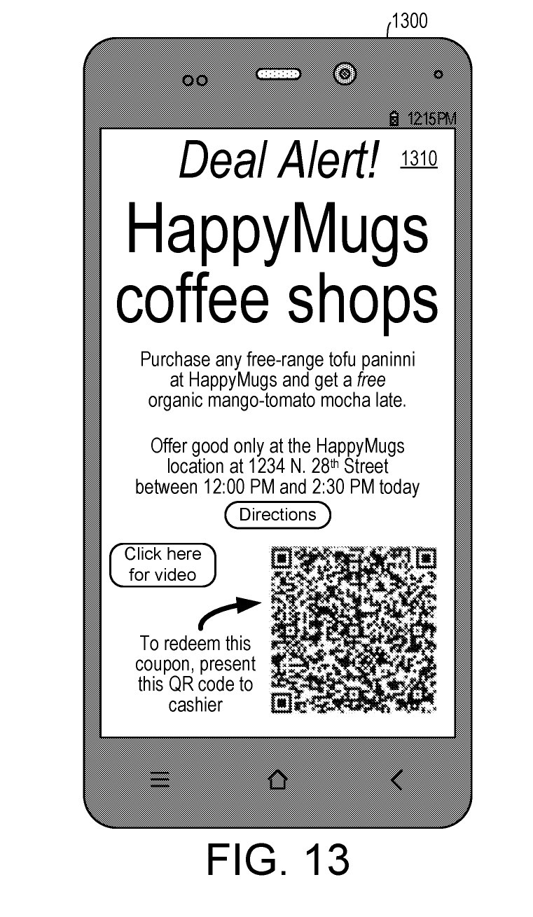

One example of a content 1310 displayed on an end user's phone 1300 in response to the phone being detected within an inclusion zone is shown in FIG. 13. In this case, the system downloads content (such as a coupon) to the smart phone that is specific to a location during a predetermined period of time. Typically, when location specific content is made available on the smart phone, a notification such as a sound or vibration is generated by the smart phone to notify the end user of the posting of the content on the smart phone. The content 1310 could include the name and address of the customer's place of business, a statement of an offer to induce the patron to visit the place of business, a QR code or a bar code that can uniquely identify the deal being offered to the patron and that can be used to redeem the offer and buttons that connect to other functionality. For example, if the patron clicks on the “Directions” button, the app can connect with a GPS locating phone app that provides the patron with real time directions to the customer's place of business.

While the content shown in FIG. 13 is a coupon, other types of content (such as advertising, videos, songs, pod casts, etc.) may be sent to the phone. Various types of location-specific content can be transmitted to the end user's phone, including: electronic coupons that are redeemable at a business within a predetermined range of the smart phone; advertising videos about a business within a predetermined range of the smart phone; visual advertisements about a business within a predetermined range of the smart phone; audible advertisements about a business within a predetermined range of the smart phone, etc.

Because of the variety of types of content that may be downloaded to the smart phone, the system can perform the functions of a loyalty card system without requiring the user to carry a physical loyalty card. They system can also provide dynamic suggestions to users. For example, when the system notices that the user is in a supermarket and determines that the user regularly buys dog food when visiting the supermarket, the system can download a reminder to buy dog food and can also offer a coupon for a specific brand of dog food. The system can also track coupon usage by the end user.

The analytical engine at the server can analyze user response dynamically and adjust the business rules accordingly. If it notices that a given promotion has a low response rate, it can change the nature of the promotion. For example, if the server sends out coupons for a 10% discount for a given product, but the coupons have a low redemption rate, the system can resend the coupons but change them to offer a 15% discount. The app can manage the use of the coupons, limiting then as to when they are valid and how many repeat uses of a coupon are allowed.

The above described embodiments, while including the preferred embodiment and the best mode of the invention known to the inventor at the time of filing, are given as illustrative examples only. It will be readily appreciated that many deviations may be made from the specific embodiments disclosed in this specification without departing from the spirit and scope of the invention. Accordingly, the scope of the invention is to be determined by the claims below rather than being limited to the specifically described embodiments above.

What is claimed is:

1. A smart phone used by an end user, comprising:
(a) a positioning circuit;
(b) a computer readable memory; and
(c) an app resident on the computer readable memory and configured to:
(i) periodically cause the positioning circuit to determine a preferred location of the smart phone;
(ii) transmit the preferred location to a remote server via a network;
(iii) execute a plurality of local rules based on the preferred location;
(iv) receive location-specific content that is selected based on the preferred location from the server via the network; and
(v) present the location-specific content to the end user.

2. The smart phone of claim 1, wherein the positioning circuit comprises a GPS chipset.

3. The smart phone of claim 1, wherein the app is configured to:
(a) download from the server a first set of business rules that are specific to the preferred location and the phone app;
(b) execute the first set of business rules;
(c) download from the server a second set of business rules that are specific to a second location when the smart phone has moved from the preferred location to the second location; and
(d) execute the second set of business rules when the smart phone is within a predetermined range of the second location.

4. The smart phone of claim 1, wherein the positioning circuit is configured to determine the preferred location based on triangulation between cell phone towers.

5. The smart phone of claim 1, wherein the positioning circuit is configured to determine the preferred location based on communication with short distance wireless communication devices.

6. The smart phone of claim 1, wherein when the app periodically causes the positioning circuit to determine a location of the smart phone, the app will detect a plurality of locations that each comprise a latitude, a longitude and a position radius associated therewith, and where the app selects a location of the plurality of locations with the shortest radius as the preferred location.

7. The smart phone of claim 1, wherein the app is further configured to determine if the smart phone has moved to a new location that is a distance greater than a predetermined threshold and upon detecting that the smart phone has moved to the new location, transmit the new location to the remote server.

8. The smart phone of claim 7, wherein the smart phone receives new location-specific content from the remote server when the smart phone has moved to the new location.

9. The smart phone of claim 1, wherein the location-specific content comprises content from a list of content types consisting of: an electronic coupon that is redeemable at a business within a predetermined range of the smart phone; an advertising video about a business within a predetermined range of the smart phone; a visual advertisement about a business within a predetermined range of the smart phone; an audible advertisement about a business within a predetermined range of the smart phone; and combinations thereof.

10. The smart phone of claim 1, wherein the location-specific content comprises content that is specific to a location during a predefined period of time.

11. The smart phone of claim 10, wherein the location-specific and time-specific content comprises:
(a) a coupon that is redeemable at a preselected store during a preselected time range; and
(b) a notification that the coupon has been posted to the smart phone.

12. The smart phone of claim 1, wherein the app is configured to change location determining frequency when the preferred location is within a predetermined action zone.

13. The smart phone of claim 1, wherein the app is configured to display the preferred location on the smart phone.

14. The smart phone of claim 12, wherein the location determining frequency is reduced when the predetermined action zone is an area outside of a predetermined range from a selected location, thereby reducing battery discharge rate of the smart phone and reducing impact on server resources.

15. The smart phone of claim 12, wherein the location determining frequency is increased when the predetermined action zone is an area inside a store, thereby enabling tracking of the smart phone within the store.

16. A method of interacting with a smart phone, comprising the steps of:
(a) generating a set of business rules that set forth a course of actions that are based on a location of the smart phone;
(b) coupling the set of business rules to a smart phone locating engine and an inclusion/exclusion zone engine so as to generate a phone app;
(c) downloading the phone app from a server to the smart phone;
(d) executing a consent process that receives input from an end user indicating that the end user consents to the smart phone being located by the customer;
(e) periodically employing the smart phone locating engine to determine a plurality of locations for the smart phone, in which each location includes at least a latitude, a longitude and a precision indicator;
(f) selecting a preferred location from the plurality of locations wherein the precision indicator of the preferred location indicates that the preferred location is the most precise of the plurality of locations;
(g) applying the business rules to the preferred location and executing the course of actions based on the preferred location;
(h) employing the inclusion/exclusion zone engine to determine when the smart phone is in an action zone; and
when the smart phone is in an action zone, delivering location-specific content to the phone.

17. The method of claim 16, wherein the action zone comprises an inclusion zone.

18. The method of claim 16, wherein the step of periodically employing the phone locating engine to determine a plurality of locations for the smart phone is performed at a frequency that depends on at least one sensed characteristic associated with the smart phone.

19. The method of claim 18, wherein when the sensed characteristic that the smart phone is inside the action zone, then the frequency is relatively high; and wherein when the sensed characteristic is that the smart phone is outside the action zone, then the frequency is relatively low.

20. The method of claim 16, further comprising the step of storing on the server a plurality of locations of the smart phone over time and associating actions taken by the smart phone with corresponding locations of the smart phone.

21. The method of claim 20, further comprising the steps of:
(a) analyzing the plurality of locations of the smart phone and the associated actions; and
(b) dynamically changing the set of business rules that set forth the course of actions based thereon.

22. The method of claim 20, wherein the location-specific content comprises content from a list of content types consisting of: an electronic coupon that is redeemable at a business within a predetermined range of the smart phone; an advertising video about a business within a predetermined range of the smart phone; a visual advertisement about a business within a predetermined range of the smart phone; an audible advertisement about a business within a predetermined range of the smart phone; and combinations thereof.

23. The method of claim 20, wherein the location-specific content comprises content that is specific to a location during a predetermined period of time.

24. The method of claim 23, wherein the location-specific and time-specific content comprises a coupon that is redeemable at a preselected store during a preselected time range.

25. The method of claim 16, further comprising the steps of:
(a) detecting when the smart phone is approaching an area of limited cellular service connectability; and
(b) downloading the set of business rules to the smart phone when the smart phone is approaching an area of limited cellular service connectability.

26. The method of claim 16, further comprising the steps of:
(a) at the server, determining when at least a predetermined number of smart phones are within a predetermined distance of the preferred location;
(b) when the predetermined number of smart phones are within the predetermined distance of the preferred location, then querying each of the smart phones to determine if each smart phone user desires to participate in a group activity; and
(c) to each smart phone that indicates to the server that it agrees to participate in the group activity, transmit content specific to the group activity.
